(19) United States
(12) Patent Application Publication
(10) Pub. No.: US 2004/0066517 A1
(43) Pub. Date: Apr. 8, 2004

(54) Interferometry-based method and apparatus for overlay metrology

(76) Inventors: Hsu-Ting Huang, Sunnyvale, CA (US); Abdurrahman Sezginer, Los Gatos, CA (US); Kenneth Johnson, Santa Clara, CA (US); Adam Norton, Palo Alto, CA (US)

Correspondence Address: STALLMAN & POLLOCK LLP, Suite 290, 121 Spear Street, San Francisco, CA, 94105, US

(21) Appl. No.: 10/639,661

(22) Filed: Aug. 12, 2003

Related U.S. Application Data
(60) Provisional application No. 60/408,264, filed on Sep. 5, 2002.
(60) Provisional application No. 60/488,017, filed on Jul. 17, 2003.

(51) Int. Cl. G01B 11/02; G01B 9/02

(52) U.S. Cl. 356/509

(57) ABSTRACT

A method for optically inspecting and evaluating a semiconductor wafer includes projecting a probe beam at two overlay targets. Each overlay target includes an upper grating and a lower grating. At each target, the combined intensity of the 1^{st} diffracted orders generated by the upper and lower gratings are measured. The combined intensity of the −1^{st} diffracted orders generated by the upper and lower gratings are also measured for each target. The method then calculates an overlay offset between an upper layer and a lower layer as a function of the measured intensity information.

### PRIORITY CLAIM

This application claims priority from U.S. Provisional Patent Applications, Serial No. 60/408,264, filed Sep. 5, 2002, and 60/488,017, filed Jul. 17, 2003, which are incorporated in this document by reference.

### TECHNICAL FIELD

This invention relates to measuring the overlay alignment accuracy of a pair of patterned layers on a semiconductor wafer, possibly separated by one or more layers, made by two or more lithography steps during the manufacture of semiconductor devices.

### BACKGROUND OF THE INVENTION

Manufacturing semiconductor devices involves depositing and patterning several layers overlaying each other. For example, gate interconnects and gates of an integrated circuit are formed at different lithography steps in the manufacturing process. The tolerance of alignment of these patterned layers is less than the width of the gate.

Overlay is defined as the displacement of a patterned layer from its ideal position aligned to a layer patterned earlier on the same wafer. Overlay is a two dimensional vector (Δx, Δy) in the plane of the wafer. Overlay is a vector field, i.e., the value of the vector depends on the position on the wafer. Perfect overlay and zero overlay are used synonymously. Overlay and overlay error are used synonymously. Depending on the context, overlay may signify a vector or one of the components of the vector.

Overlay metrology provides the information that is necessary to correct the alignment of the stepper-scanner and thereby minimize overlay error with respect to previously patterned layers. Overlay errors, detected on a wafer after exposing and developing the photoresist, can be corrected by removing the photoresist, repeating exposure on a corrected stepper-scanner, and repeating the development of the photoresist. If the measured error is acceptable but measurable, parameters of the lithography process could be adjusted based on the overlay metrology to avoid excursions for subsequent wafers.

Most prior overlay metrology methods use built-in test patterns etched or otherwise formed into or on the various layers during the same plurality of lithography steps that form the patterns for circuit elements on the wafer. One typical pattern, called “box-in-box” consists of two concentric squares, formed on a lower and an upper layer, respectively. “Bar-in-bar” is a similar pattern with just the edges of the “boxes” demarcated, and broken into disjoint line segments. The outer bars are associated with one layer and the inner bars with another. Typically one is the upper pattern and the other is the lower pattern, e.g., outer bars on a lower layer, and inner bars on the top. However, with advanced processes the topographies are complex and not truly planar so the designations “upper” and “lower” are ambiguous. Typically they correspond to earlier and later in the process. The squares or bars are formed by lithographic and other processes used to make planar structures, e.g., chemical-mechanical planarization (CMP). Currently, the patterns for the boxes or bars are stored on lithography masks and projected onto the wafer. Other methods for putting the patterns on the wafer are possible, e.g., direct electron beam writing from computer memory.

In one form of the prior art, a high performance microscope imaging system combined with image processing software estimates overlay error for the two layers. The image processing software uses the intensity of light at a multitude of pixels. Obtaining the overlay error accurately requires a high quality imaging system and means of focusing the system. One requirement for the optical system is very stable positioning of the optical system with respect to the sample. Relative vibration would blur the image and degrade the performance. This is a difficult requirement to meet for overlay metrology systems that are integrated into a process tool, like a lithography track. High-acceleration wafer handlers in the track cause vibration. The tight space requirements for integration preclude bulky isolation strategies.

As disclosed in U.S. Patent Application Serial No. 2002/0158193 (incorporated in this document by reference) one approach to overcoming these difficulties is to incorporate special diffraction gratings, known as targets, within semiconductor wafers. The targets are measured using scatterometry to perform overlay metrology. Several different grating configurations are described for the overlay targets. The simplest embodiment uses two grating stacks, one for x-alignment and one for y (each grating stack comprising two grating layers). An alternative embodiment uses two line grating stacks each for x and y (four grating stacks total). Still another embodiment uses three line grating stacks in combination to simultaneously measure both x and y alignment. (See also PCT publication WO 02/25723A2, incorporated herein by reference).

Scatterometry is proving to be an effective tool for measuring overlay errors. At the same time, analyzing scatterometry measurements is generally a computationally intensive, time consuming process that can only be accomplished using complex mathematical models. In some cases, it may be difficult to accomplish the required computations within the time available.

A second approach measures overlay by measuring the difference in the reflection efficiencies of the ±1st diffracted orders. This approach uses a target that includes two overlapping line gratings of equal pitch. When the lines of one grating are centered on the lines or spaces of the other, the ±1st diffraction orders have the same amplitude due to symmetry. When the two gratings are offset with respect to each other, the symmetry is broken and the difference in the amplitudes of the ±1st orders correlate to offset. The proportionality constant (i.e., the constant that relates the difference in amplitude to overlay) depends on geometrical details of the sample and the optical properties of all layers in the sample. The proportionality constant is subject to change from sample to sample, and even within the same sample. As a result, this method does not lead to practical measurements. Methods of this type are described in U.S. Patent Serial No. 4,200,395 and the article “Light diffraction based overlay measurement”, Metrology, Inspection, and Process Control for Microlithography XV, Bischoff, et. al., N. T. Sullivan, Ed., p. 222-233, Vol. 4344, SPIE, Bellingham, 2001. Both of these documents are incorporated by reference.

For these reasons and others, there is a continuing need for fast, accurate or otherwise efficient methods for measuring overlay in semiconductor wafers. This is particularly true for integrated metrology solutions where overlay measurements must be made on a real-time basis as part of a production environment.

### BRIEF DESCRIPTION OF THE DRAWINGS

FIGS. 1A through 1D are various views of an embodiment of an overlay target as provided by the present invention.

FIG. 2 shows the diffracted orders produced during measurement of the overlay target shown in FIGS. 1A through 1D.

FIG. 3 shows an embodiment of the overlay target designed to provide additional measurements values.

FIG. 4 shows an embodiment of the overlay target designed to provide measurement in two dimensions.

FIG. 5 shows an alternate embodiment of the overlay target designed to provide measurement in two dimensions.

FIG. 6 shows a metrology system designed to measure overlay using the overlay targets shown in FIGS. 1 through 5.

FIG. 7 shows a second metrology system designed to measure overlay using the overlay targets shown in FIGS. 1 through 5.

FIG. 8 shows the appearance of the overlay target of FIG. 4 that corresponds to a gross overlay error.

FIG. 9A shows the diffraction pattern that corresponds to the gross overlay condition.

FIG. 9B shows the diffraction pattern that corresponds to the non-gross overlay condition.

### DETAILED DESCRIPTION OF THE PREFERRED EMBODIMENTS

Overlay Target

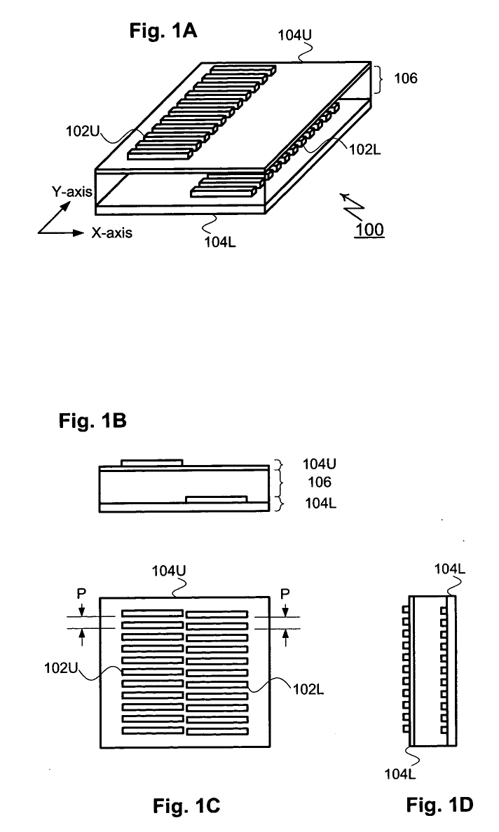

As shown in FIGS. 1A through 1D, an embodiment of the present invention provides a target 100 for interferometry-based overlay metrology. Overlay target 100 includes an upper grating 102U and a lower grating 102L. Grating 102U is formed in an upper layer 104U and grating 102L is formed in a lower layer 104L. Upper and lower layers 104 may be separated by one or more intermediate layers 106. Intermediate layers 106 are transparent or semitransparent materials such as inter-layer dielectrics, stop layers, and anti-reflective coatings.

Each grating 102 is formed as a series of parallel lines spaced at a constant pitch (in this document, period, spatial period, and pitch are used synonymously). The same pitch is used for upper grating 102U and lower grating 102L and the lines in upper grating 102U are parallel to the lines in lower grating 102L. In FIGS. 1A through 1D, the lines of gratings 102 are shown to have a rectangular cross section or profile. In general, it should be noted that this is a simplification and that profiles in actual implementations are typically more complex.

Gratings 102 are positioned to be non-overlapping. This is shown most clearly in FIGS. 1B and 1C. The gratings while substantially non-overlapping, can be relatively close to each other. A suitable gap would be on the order of 0.5 to one micron. Preferably, the gap should be sufficiently large so that light diffracted from one grating does not illuminate the other grating and be diffracted in a manner that adds significantly to the measured signal. We also note that the separation between the upper and lower gratings creates interference fringes within the ±1st order spots at the detector plane. The larger the separation, the higher the spatial frequency of the fringes at the detector plane. To avoid having to account for these effects, a small separation is desirable.

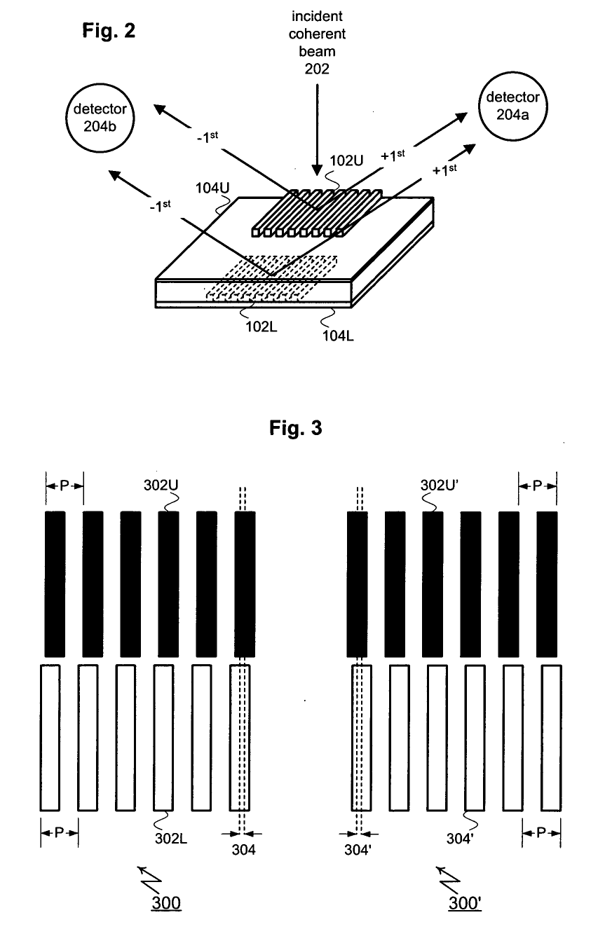

FIG. 2 shows the interaction between a probe beam 202 and overlay target 100. Probe beam 202 is typically coherent and is typically generated by a suitable laser source. Probe beam 202 is normally incident on overlay target 100 where it illuminates gratings 102U and 102L simultaneously. The size of overlay target 100 is comparable to or smaller than the coherence length of probe beam 202. Typically, this is accomplished by expanding probe beam 202 to cover overlay target 100.

Upper grating 102U diffracts probe beam 202 into diffracted orders. As shown in FIG. 2, this includes a +1^{st} diffracted order and a −1^{st} diffracted order. Lower grating 102L similarly creates a respective set of +1^{st} and −1^{st} diffracted orders. This requires the ±1^{st} order to be propagating (not evanescent) which in turn requires:

p≧λ (1)

where P is the period of upper grating 102U and lower grating 102L. In practice, this means that the period of upper and lower gratings 102 and the wavelength (or wavelengths) of probe beam 202 are chosen to be mutually compatible. It is also possible to use non-first diffraction orders. In this case, FIG. 2 is generalized with upper and lower gratings 102 producing respective n^{th} and −n^{th} diffracted orders (where n is an integer other than 1), rather than just +1^{st} and −1^{st} diffracted orders, as shown. Equation (1)is then generalized to:

P≧nλ (2)

The 1^{st} order diffracted beams from the upper and lower gratings 102 are combined at a detector 204a. Similarly, the −1^{st} order diffracted beams from the upper and lower gratings 102 are combined at a detector 204b. Detectors 204 provide output signals that are proportional to the light power that they receive. Detectors 204 are typically members on a detector array but may also be separate photodetectors. Alternately, a single detector may be physically repositioned to capture the 1^{st} and −1^{st} order diffracted beams in sequence.

If only one of the gratings 102 were present, the amplitude of the diffracted orders reaching detector 204a would be equivalent to the amplitude reaching detector 204b. This follows because probe beam 202 is directed normally against overlay target 100 and because the lines in upper and lower gratings 102 have symmetric cross-sections. With respect to the amplitude of probe beam 202, the 1^{st} and −1^{st} diffracted orders have the following complex amplitudes:

| | 1^{st} order | |
|---|---|---|
| | diffracted beams | −1^{st} order diffracted beams |
| upper grating 102U | \|a\|e^{iφ}ₐe^{+i2πΔx/P} | \|a\|e^{iφ}ₐe^{-i2πΔx/P} |
| lower grating 102L | \|b\|e^{iφ}_{b} | \|b\|e^{iφ}_{b} |

In these equations, the amplitudes a and b, and the phase angles φₐ and φ_{b} depend on the properties of the sample and the metrology target. The phase of the diffracted orders reaching each detector 204 is a function of the offset Δx between upper and lower gratings 102. When upper grating 102U is offset by Δx in the direction of its pitch, there is a phase difference of 4πΔx/P radians between the 1^{st} and 1^{st} orders diffracted by the upper grating. The difference in phase causes the diffracted orders received by each detector 204 to interfere. For detector 204a, the two 1^{st} diffracted orders have the intensity:

$$\begin{matrix}{I}^{+} = {\vert a \vert}^{2} + {\vert b \vert}^{2} + 2 \vert ab \vert cos ( {φ}_{a} - {φ}_{b} + 2 π Δ x / P ) \\ = A + B cos ( φ + 2 π Δ x / P )\end{matrix} \qquad ( 3 )$$

For detector 204b, the two −1^{st} diffracted orders have the intensity:

$$\begin{matrix}{I}^{-} = {\vert a \vert}^{2} + {\vert b \vert}^{2} + 2 \vert ab \vert cos ( {φ}_{a} - {φ}_{b} - 2 π Δ x / P ) \\ = A + B cos ( φ - 2 π Δ x / P )\end{matrix} \qquad ( 4 )$$

In these equations A, B, and φ depend on the properties of the sample that includes overlay pattern 100. For metrology, the goal is to obtain Δx without the knowledge of A, B and φ. This is possible if two targets (denoted in this document by subscripts 1 and 2) are measured by the same instrument. This results in the following intensities:

I₁⁺=A+B cos (φ+2π(r₁+Δx)/P) (5)

I₁⁻=A+B cos (φ−2π(r₁+Δx)/P) (6)

I₂⁺=A+B cos (φ+2π(r₂+Δx)/P) (7)

I₂⁻=A+B cos (φ−2π(r₂+Δx)/P) (8)

In these equations, Δx represents the unknown overlay caused by the misalignment of the lithography process. The goal is to measure Δx. The offset bias r₁ is intentionally introduced and it is well known and controlled. For example, the upper grating 102U is offset by r₁/(magnification) in target 1 on the reticle for the upper layer. The offset is in the direction of the pitch, i.e., perpendicular to the grating lines. Similarly, r₂ is the offset bias for the upper grating in target 2. Offset bias and reticle offset are used synonymously. To provide the additional measurements, an embodiment of the present invention may be constructed as shown in FIG. 3. For this embodiment, two overlay targets 300 and 300′ are used. Overlay targets 300 are structurally analogous to overlay target 100 of FIG. 1. They include an upper grating 302U and a lower grating 302L. The two gratings are formed on respective layers (not specifically shown) within a semiconductor wafer. As was the case for overlay target 100, the two layers are formed at different times during the fabrication process with the lower layer being formed earlier and the upper layer being formed later. A common period is used for all of the gratings 302 in overlay targets 300.

Each target 300 has an offset (labeled 304 and 304′) between its upper and lower gratings 302. For target 300, this offset is labeled 304, for target 300′ the offset is labeled 304′. When the layers that include upper and lower gratings 302 are in perfect alignment, offset 304 is equal to the grating period P divided by eight or P/8. Offset 304′ (i.e., the offset between the upper and lower gratings of target 300′) is equal to −P/8 (once again, when alignment is perfect). The quantity (offset 304−offset 304′) remains constant at P/4 even as the alignment between the layers that include upper and lower gratings 302 changes. This is because changes in overlay alignment that increase or decrease offset 304 have the opposite effect on offset 304′

Intensities I₁⁺ and I₁⁻ are preferably measured simultaneously on target 300. Intensities I₂⁺ and ₂⁻ are preferably measured simultaneously on target 300′. With (offset 304−offset 304′) equal to P/4, Ax may be calculated as:

Δx=arctan ((I₁⁺−I₁⁻+I₂⁺−I₂⁻)/(I₁⁺−I₁⁻−I₂⁺−I₂⁻))P/(2π) (9)

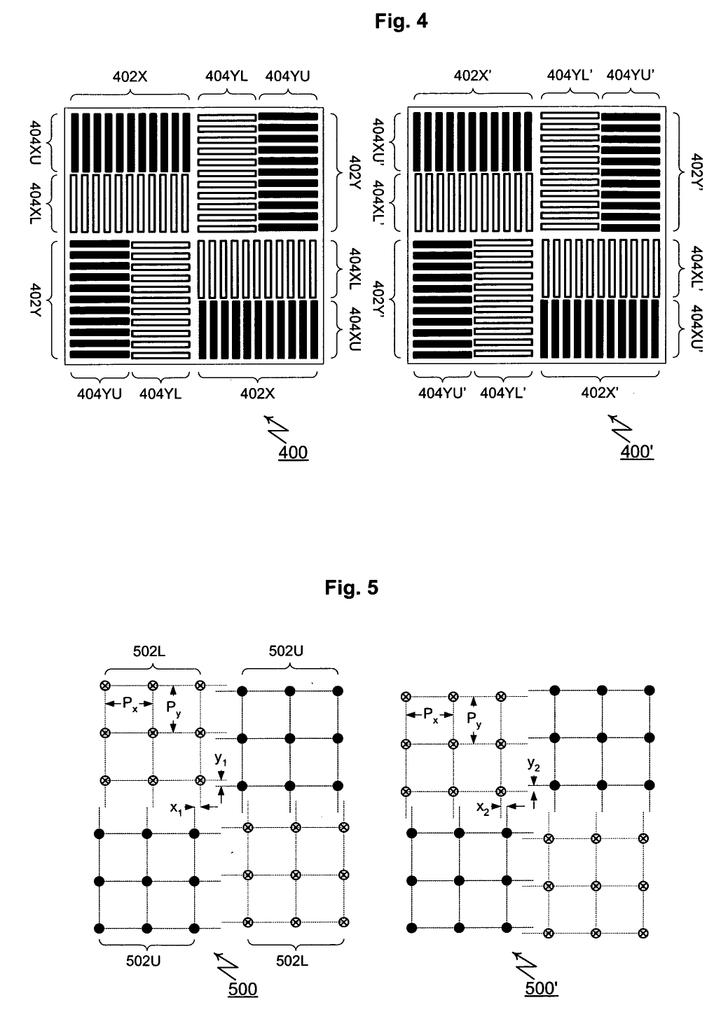

In general, it is useful to characterize overlay alignment in both x and y dimensions (i.e., measurements for Δx and Δy). FIG. 4 shows an embodiment of the present invention constructed for this type of measurement. For this embodiment, two overlay targets 400 and 400′ are used. Overlay target 400 includes a sub-target 402X for measurement in the x direction and a sub-target 402Y for measurement in the y direction. Each sub-target 402 has two separate portions that are evenly distributed within target 400. This increases the accuracy of the measurement by reducing sensitivity to changes in measurement spot location. It also allows sub-targets 402 to be distributed within the generally square shape of target 400. At the same time, it should be noted that it is possible to use more (or fewer) portions for each sub target 402.

Each sub-target 402 includes upper and lower gratings. For sub-target 402X, the upper grating is labeled 404XU and the lower grating is labeled 404XL. For sub-target 402Y, the upper grating is labeled 404YU and the lower grating is labeled 404YL. The upper and lower gratings 404 are formed on respective layers (not specifically shown) within a semiconductor wafer. As was the case for overlay target 100, the two layers are formed at different times during the fabrication process with the lower layer being formed earlier and the upper layer being formed later.

Overlay target 400′ is constructed to be a near copy of target 400. All of the structural components of target 400 are repeated, except the offset biases of 400 and 400′ (r₁ and r₂) are different. Overlay target 400′ includes two sub-targets (labeled 402X′ and 402Y′) each of which is constructed using upper and lower gratings (labeled 404XU′ and 404XL′ for sub-target 402X′ and 404YU′ and 404YL′ for sub-target 402Y′). Sub-targets 402X′ and 402Y′ are also subdivided and distributed as described for sub-targets 402X and 402Y in overlay target 400.

Sub-target 402X in overlay target 400 is logically paired with sub-target 402X′ in overlay target 400′. All of the gratings in the two sub targets 402X use a common period. Each sub-target 402X has an offset between its upper grating 404XU and lower grating 404XL. The offsets for sub-target 402X and sub-target 402X′ are chosen so that (offset (sub-target 402X)−offset (sub-target 402X′)) is equal to P/4. Typically, this is done by constructing sub-target 402X to have an offset bias of P/8 and sub-target 402X′ to have an offset bias of −P/8. The P/4 difference between the offset biases of targets 400 and 400′ is necessary to use the simple equation (9) but other values are possible for the regression algorithm described in the following sections.

In a similar fashion, sub-target 402Y in overlay target 400 is logically paired with sub-target 402Y′ in overlay target 400′. All of the gratings in the two sub targets 402Y use a common period. Each sub-target 402Y has an offset between its upper grating 404YU and lower grating 404YL. The offsets for sub-target 402Y and sub-target 402Y′ are chosen so that (offset (sub-target 402Y)−offset (sub-target 402Y′)) is equal to P/4. Typically, this is done by constructing sub-target 402Y to have an offset bias of P/8 and sub-target 402Y′ to have an offset bias of −P/8.

In essence, the implementation of FIG. 4 provides two copies of the overlay target 300 shown in FIG. 3. One copy includes sub-targets 402X and 402X′ and is used to measure offset Δx. The second copy includes sub-targets 402Y and 402Y′ and is used to measure offset Δy. Different periods may be used for the x and y directions but the difference in offset is preferably equal to P/4 for each dimension.

Overlay targets 400 and 400′ are typically placed in a scribe line between dies within a semiconductor wafer. Target 400 is illuminated and measured without substantially illuminating target 400′ and target 400′ is measured without substantially illuminating target 400. Alternatively, the detection system may be arranged to differentiate scattering from the two targets. The x-measuring gratings 404XU, 404XL and the y-measuring gratings 404YU, 404YL of target 400 are typically illuminated and measured simultaneously because the diffracted orders of the x-gratings and the y-gratings propagate in different directions. This allows the different diffracted orders to be collected by different detectors simultaneously.

FIG. 5 shows an alternative for the implementation of FIG. 4. In this implementation, two overlay targets 500 and 500′ are used. Each overlay target 500 includes an upper three-dimensional grating 502U and a lower three-dimensional grating 502L. Gratings 502 are formed as arrays of cylindrical holes (vias) or posts on two separate layers (i.e., an upper layer and a lower layer). Arrays of other three-dimensional structures can also be used. As shown in FIG. 5, gratings 502 may be subdivided into portions and distributed within overlay targets 500. In FIG. 5, the upper grating 502U in target 500 is disposed symmetrically into two portions. The two portions are on a common grid (array). That is, if the array of the first portion is extended with equal spacing, the holes of the second portion and the holes of the first portion, extended, coincide. The same is true for grating 502L.

The holes (or posts) in overlay targets 500 are spaced using a common period in the x direction (labeled Pₓ) and a common period in the y direction (labeled P_{y}). Pₓ and P_{y} may have the same or different values. The offset bias of target 500 is x₁ in the x-direction and y₁ in the y-direction. The offset bias of target 500′ is x₂ in the x-direction and y₂ in the y-direction. Typically, x₁=Pₓ/8, and x₂=−Pₓ/8, y₁=P_{y}/8, y₂=−P_{y}/8. Overlay targets 500 and 500′ are typically placed in a scribe line between dies within a semiconductor wafer. Targets 500 and 500′ are measured substantially independently. Target 500 is measured without substantially detecting light reflected from target 500′ and target 500′ is measured without substantially detecting light reflected from target 500. Each target 500 generates at least four diffracted orders, which have associated order indices {−1, 0}, {1, 0}, {0, −1}, and {0, 1}. The {−1, 0}, {1, 0} orders propagate in a plane parallel to the x axis. These orders are only sensitive to the x component of the overlay offset. The other two first orders ({0, −1}, and {0, 1}) propagate in a plane parallel to the y axis, and are sensitive to y offset. Four detector channels are typically used to collect all four first orders. The x and y detector signals are processed independently in the manner described previously to obtain simultaneous measurements of both the x and y offsets.

Metrology System

As shown in FIG. 6, an embodiment of the present invention includes a metrology system 600 for use with the overlay targets described in FIGS. 1 through 5. Metrology system 600 includes an illumination source 602 that produces a mono or polychromatic probe beam. A polychromatic probe beam is generated by combining multiple laser beams, using a laser with more than one line, or sequentially changing the wavelength of a tunable laser. The probe beam is expanded or collimated by a lens 604 and directed towards a beam splitter 606. Beam splitter 606 redirects the probe beam though an objective lens 608 with a large numerical aperture and onto an instance of an overlay target 610.

Interaction with overlay target 610 diffracts the probe beam into diffracted orders. The diffracted orders (or a subset of the diffracted orders) are collected by objective lens 608 and directed to a detector 612. Detector 612 is typically a charge coupled device (CCD) but other detector technologies may also be used. A beam dump 614 preferably eliminates the specular portion of the energy received by detector 612. This limits blooming in the detector array and minimizes light scattering inside the metrology system 600. Alternatively, the collimated light that was reflected from the sample may be focused on a pinhole to select light scattered from only one target. Light that passes through the pinhole is again collected and collimated before detection.

For the design of FIG. 6, there is a tradeoff between numerical aperture and working distance. Larger numerical apertures are generally associated with smaller working distances. The following table illustrates this for two different numerical apertures. The first is relatively large (0.85) and corresponds to relatively small working distance of 0.28 mm. The second example uses a smaller numerical aperture of 0.5 with a larger working distance of 15 mm. The use of the smaller numerical aperture requires the use of a larger grating period (such as 1600 nm) for subject 610. The angle θ in the table is the angle between the 1^{st} diffracted order and the axis of the optical system which is normal to the plane of the wafer.

NA

| | |
|---|---|
| .85 | 0.5 |

Working Distance (mm)

| | |
|---|---|
| 0.28 | 15 |

Grating Period (nm)

| | 800 | | 1600 | |
|---|---|---|---|---|
| Wavelength | sin (θ) | θ (deg) | sin (θ) | θ (deg) |
| 673 | 0.84 | 57.3 | 0.42 | 24.9 |
| 532 | 0.67 | 41.7 | 0.33 | 19.4 |
| 470 | 0.59 | 36.0 | 0.29 | 17.1 |
| 404 | 0.51 | 30.3 | 0.25 | 14.6 |

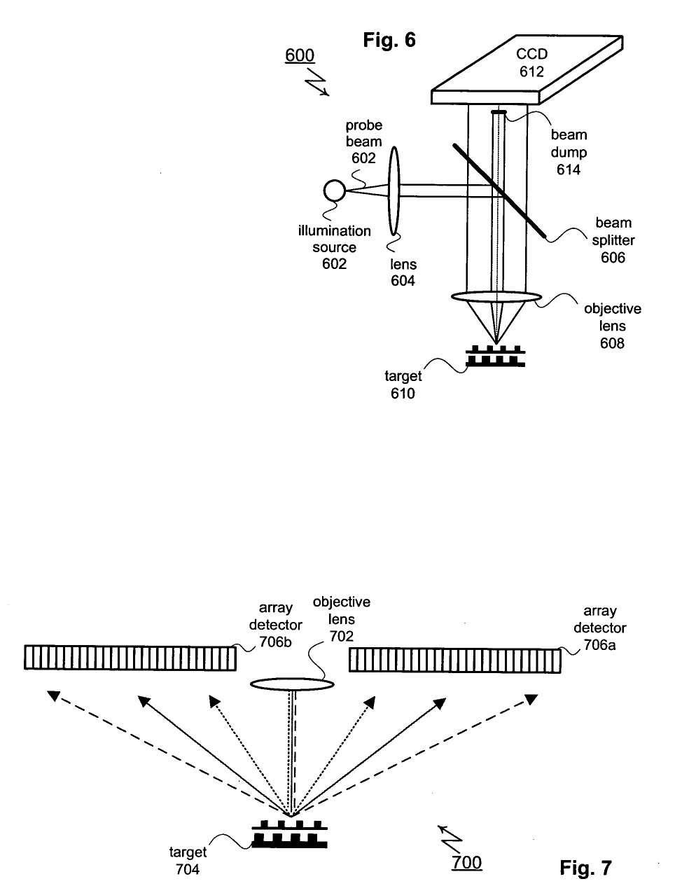

FIG. 7 shows a second embodiment of a metrology system (labeled 700) for use with the overlay targets described in FIGS. 1 through 5. In this case, light from an illumination source (not shown) is projected through an objective lens 702 and onto an instance of an overlay target 704. Interaction with overlay target 704 diffracts the probe beam into diffracted orders. Detector arrays 706a and 706b measure the diffracted orders without the aid of an objective. This lens-less design can achieve a large working distance and a large effective numerical aperture of detection. Detector arrays 706 are typically 2-dimensional arrays of CCD devices but other suitable technologies such as linear photodiode arrays may also be used. Four arrays are used to detect the orders (+1,0), (−1,0), (0,+1), and (0,−1). Only two such arrays are shown in FIG. 7 for clarity. Detector arrays, as opposed to single detectors, are useful to make multi-wavelength measurements since different colors diffract at different angles.

As shown in FIG. 7, objective lens 702 is used for illumination and not for collection. As a result, the design of FIG. 7 is not characterized by the numerical aperture/working distance tradeoff described for the design of FIG. 6. This allows the design of FIG. 7 to have an effectively large numerical aperture combined with a relatively large working distance and still work at a relatively small grating period (such as 800 nm). The radial (transverse) distance from the axis of the illuminating beam to the first order diffracted beam on the detector array is given by the table below for various wavelengths:

| | Grating Period (nm) | | |
|---|---|---|---|
| | 800 | | |
| | Working Distance (mm) | | |
| | 15 | | |
| | | | Transverse Distance (mm) = |
| Wavelength | sin (θ) | θ (deg) | tan (θ)* Working Distance |
| 673 | 0.84 | 57.3 | 23.3 |
| 532 | 0.67 | 41.7 | 13.4 |
| 470 | 0.59 | 36.0 | 10.9 |
| 404 | 0.51 | 30.3 | 8.8 |

Overlay targets with periodic structures can give erroneous results for large overlay errors. This can be deduced from Equation (9) since the tangent function is periodic with a period of π. This limits the range of overlay that may be unambiguously measured using Equation (9) to [−P/4 . . . P/4]. In practice, it is possible for overlay errors to exceed this range. For example, FIG. 8 shows an instance of target 400 (of the type originally shown in FIG. 4) as it would appear for a large overlay error. The large overlay error causes a portion of upper grating 404XU to overlap a portion of lower grating 404YL creating a cross-hatched pattern.

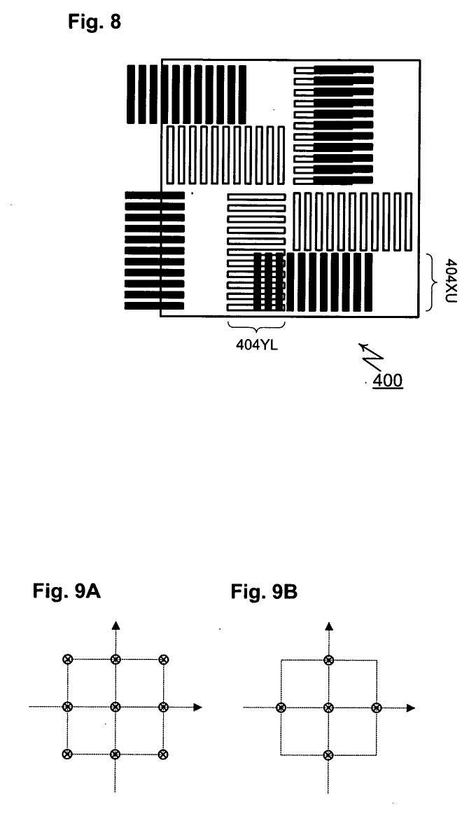

To detect gross overlay errors, the measurement process is preferably configured to analyze the pattern of diffracted orders present at the receiving detector (such as detector 612 of FIG. 6). FIGS. 9A and 9B show two of these patterns. The first, shown in 9A corresponds to the cross-hatched pattern of FIG. 8. The second corresponds to the absence of gross overlay errors. Detection of the first type of pattern allows gross overlay errors to be detected, even when they cannot be accurately measured using Equation (9).

Regression Method

In practice, all metrology systems induce some degree of error into the measurement process. For the overlay metrology systems described above, one source of these errors is the difference in the optical efficiencies of the paths traversed by the separate diffracted orders. Path-to-path variations in components (e.g., lenses) induce differences in the diffracted orders. Different diffracted orders are also measured by different detectors or pixels. Once again, detector-to-detector (or pixel-to-pixel) variations in sensitivity tend to induce differences in the diffracted orders. Wafer tilt or wafer misalignment is another source of difference between diffracted orders. The overall result is that there may be cases where Equation (9) will not be entirely robust.

To overcome this limitation, it is possible to use a method where each of targets 400 and 400′ is measured at two orientations of the wafer: one at 0°, the other at 180°. These angles refer to rotation of the wafer with respect to an axis that is normal to the wafer. Since two diffracted orders are measured per Cartesian component of overlay, there are eight intensity measurements per wavelength per Cartesian component:

$$\begin{matrix}{I}_{1 , 0 °}^{+} = {A}^{+} + {B}^{+} cos [ + {k}^{+} ( Δ x + {r}_{1} ) - {φ}^{+} ] target 400 , + {1}^{st} order , wafer at 0 ° \\ {I}_{1 , 180 °}^{+} = {A}^{+} + {B}^{+} cos [ - {k}^{+} ( Δ x + {r}_{1} ) - {φ}^{+} ] target 400 , + {1}^{st} order , wafer at 180 ° \\ {I}_{1 , 0 °}^{-} = {A}^{-} + {B}^{-} cos [ + {k}^{-} ( Δ x + {r}_{1} ) - {φ}^{-} ] target 400 , - {1}^{st} order , wafer at 0 ° \\ {I}_{1 , 180 °}^{-} = {A}^{-} + {B}^{-} cos [ - {k}^{-} ( Δ x + {r}_{1} ) - {φ}^{-} ] target 400 , - {1}^{st} order , wafer at 180 ° \\ {I}_{2 , 0 °}^{+} = {A}^{+} + {B}^{+} cos [ + {k}^{+} ( Δ x + {r}_{2} ) - {φ}^{+} ] target {400}^{′} , + {1}^{st} order , wafer at 0 ° \\ {I}_{2 , 180 °}^{+} = {A}^{+} + {B}^{+} cos [ - {k}^{+} ( Δ x + {r}_{2} ) - {φ}^{+} ] target {400}^{′} , + {1}^{st} order , wafer at 180 ° \\ {I}_{2 , 0 °}^{-} = {A}^{-} + {B}^{-} cos [ + {k}^{-} ( Δ x + {r}_{2} ) - {φ}^{-} ] target {400}^{′} , - {1}^{st} order , wafer at 0 ° \\ {I}_{2 , 180 °}^{-} = {A}^{-} + {B}^{-} cos [ - {k}^{-} ( Δ x + {r}_{2} ) - {φ}^{-} ] target {400}^{′} , - {1}^{st} order , wafer at 180 ° & ( 10 ) \\ {k}^{\pm } = 2 π ( \frac{\pm 1}{P} + \frac{sin ( θ )}{λ} ) & ( 11 )\end{matrix}$$

The unknowns A⁺, B⁺, φ⁺, A⁻, B⁻, φ⁻ depend on the details of the target and the instrument and they are of no practical interest. There are six such unknown parameters per measurement wavelength. ƒ is the unknown deviation from normal incidence and Δx is the unknown overlay that is to be measured. There are (6N_{λ}+2) unknown quantities where Nλ is the number of measurement wavelengths. There are 8N_{λ} intensity measurements per Cartesian component of overlay. The problem reduces to approximately solving the system of equations (10) (one such system per wavelength) for the unknown parameters. Typically, this is performed in a least-squares sense using the Levenberg-Marquardt algorithm to minimize a nonlinear function of two variables, χ²(θ, Δx) This chi-square error function is calculated as:

$${χ}^{2} ( θ , Δ x ) = {\sum }_{λ} {‖ I ( λ ) - C ( λ ) {x}_{LSQ} ( λ ) ‖}^{2} \qquad ( 12 )$$

The summation is over the number of measurement wavelengths. The term I−Cx_{LSQ} is the residual of a linear least-squares problem:

I(λ)=C(λ)x(λ) (13)

Equation (13) is solved in the least-squares sense independently for each wavelength for a given set of θ, Δx values. The vector of measured intensities, I(λ), the vector of unknown coefficients, x(λ), and the matrix C(λ) are defined as:

$$I = [ \begin{matrix}{I}_{1 , 0 °}^{+} \\ {I}_{1 , 180 °}^{+} \\ {I}_{1 , 0 °}^{-} \\ {I}_{1 , 180 °}^{-} \\ {I}_{2 , 0 °}^{+} \\ {I}_{2 , 180 °}^{+} \\ {I}_{2 , 0 °}^{-} \\ {I}_{2 , 180 °}^{-}\end{matrix} ] ; x = [ \begin{matrix}{A}^{+} \\ {B}^{+} cos {φ}^{+} \\ {B}^{+} sin {φ}^{+} \\ {A}^{-} \\ {B}^{-} cos {φ}^{-} \\ {B}^{-} sin {φ}^{-}\end{matrix} ] \qquad ( 14 )$$

$$C ( λ ) = [ \begin{matrix}1 & cos [ {k}^{+} ( Δ x + {r}_{1} ) ] & sin [ {k}^{+} ( Δ x + {r}_{1} ) ] & 0 & 0 & 0 \\ 1 & cos [ {k}^{+} ( Δ x + {r}_{1} ) ] & - sin [ {k}^{+} ( Δ x + {r}_{1} ) ] & 0 & 0 & 0 \\ ⋮ & ⋮ & ⋮ & ⋮ & ⋮ & ⋮ \\ 0 & 0 & 0 & 1 & cos [ {k}^{-} ( Δ x + {r}_{2} ) ] & - sin [ {k}^{-} ( Δ x + {r}^{2} ) ]\end{matrix} ] \qquad ( 15 )$$

The least-squares solution for x is obtained by performing the QR-decomposition of C:

C=QR; x_{LSQ}=R⁻¹Q^{T}I (16)

The columns of the 8×6 matrix Q are orthonormal and R is a 6×6 upper-triangular matrix. The residual of the least squares problem is calculated without ever forming the vector x_{LSQ}:

I−Cx_{LSQ}=I−QQ^{T}I (17)

Square of the norm of the residual, ∥I(λ)−C(λ)x_{LSQ}(λ)∥, in (12) is calculated by summing the squares of the entries of the vector on the right hand side of (17). This sum of squares is further summed over measurement wavelengths to obtain χ²(θ, Δx). Reflection efficiency of the ±1^{st} orders depends on the sample and the measurement wavelength. The reflection efficiency can be small at one wavelength but it is less likely to be small over multiple wavelengths spanning a broad band. Therefore, using multiple wavelengths yields a more robust measurement.

What is claimed is:

1. A method for optically inspecting and evaluating a semiconductor wafer, the method comprising:
a) projecting a probe beam at an overlay target that includes a first upper grating and a first lower grating, where the first upper grating and first lower grating are adjacent but substantially non-overlapping;
b) measuring the combined intensity for order n diffraction of the probe beam generated by the first upper and lower gratings;
c) measuring the combined intensity for order −n diffraction of the probe beam generated by the first upper and lower gratings; and
d) calculating an overlay offset between a layer that includes the first upper grating of the overlay target and a layer that includes the first lower grating of the overlay target from the measured intensity information.

2. A method as recited in claim 1, wherein the overlay target includes a second upper grating and a second lower grating, where the second upper grating and second lower grating are substantially non-overlapping, and wherein the method further comprises the steps of:
e) measuring the combined intensity for order n diffraction of the probe beam generated by the second upper and lower gratings; and
f) measuring the combined intensity for order −n diffraction of the probe beam generated by the second upper and lower gratings and wherein the calculation of step (d) is performed using the additional measurements of step (e) and (f).

3. A method as recited in claim 1, that further comprises:
rotating the semiconductor wafer; and
repeating steps (a) though (d) to obtain additional intensity measurements.

4. A method as recited in claim 1, wherein the combined intensities are measured for a series of wavelengths.

5. A method as recited in claim 1, wherein each grating is formed as a two dimensional array of posts or vias.

6. A method as recited in claim 1, wherein each grating is formed as a series of lines.

7. A method for optically inspecting and evaluating a semiconductor wafer, the method comprising:
projecting a probe beam at an overlay target that includes a first set of non-overlapping gratings including an upper grating formed on an upper layer and a lower grating formed on a lower layer; and
calculating an overlay offset between the upper and lower layers by analyzing the diffraction imparted to the probe beam by each grating in the first set.

8. A method as recited in claim 7, that further comprises the steps of:
measuring the combined intensity for order n diffraction of the probe beam generated by each grating in the first set; and
measuring the combined intensity for order −n diffraction of the probe beam generated by each grating in the first set.

9. A method as recited in claim 7, wherein the overlay target includes a second set of non-overlapping gratings including an upper grating formed on the upper layer and a lower grating formed on the lower layer, and wherein the method further comprises the steps of:
measuring the combined intensity for order n diffraction of the probe beam generated by each grating in the second set; and
measuring the combined intensity for order −n diffraction of the probe beam generated by each grating in the second set and using the measurements from the second set to calculate the offset between the upper and lower layers.

10. A method as recited in claim 7, wherein the diffraction imparted to the probe beam is analyzed for a series of wavelengths.

11. A method as recited in claim 7, wherein each grating in the first set is formed as a two dimensional array of posts or vias.

12. A method as recited in claim 7, wherein each grating in the first set is formed as a series of lines.

13. A method for optically inspecting and evaluating a semiconductor wafer, the method comprising:
projecting a probe beam to simultaneously irradiate a grating formed on an upper layer and a non-overlapping grating formed on a lower layer; and
measuring the combined intensity for order n diffraction of the probe beam generated by the gratings;
measuring the combined intensity for order −n diffraction of the probe beam generated by the gratings; and
calculating an overlay offset between the upper and lower layers by analyzing the combined intensities.

14. A method as recited in claim 13, wherein the diffraction imparted to the probe beam is analyzed for a series of wavelengths.

15. A method as recited in claim 13, wherein each grating in the first set is formed as a two dimensional array of posts or vias.

16. A method as recited in claim 13, wherein each grating in the first set is formed as a series of lines.
